(19) United States
(12) Patent Application Publication
(10) Pub. No.: US 2001/0010059 A1
(43) Pub. Date: Jul. 26, 2001

(54) METHOD AND APPARATUS FOR DETERMINING TRAVEL TIME FOR DATA SENT BETWEEN DEVICES CONNECTED TO A COMPUTER NETWORK

(76) Inventors: STEVEN WESLEY BURMAN, SUPERIOR, CO (US); MICHAEL J. GRIFFITHS, BROOMFIELD, CO (US); JENNIFER A. WHITE, GOLDEN, CO (US); CHARLES FRANKLIN RANDALL IV, WESTMINSTER, CO (US); JOHN JAMES DOUBRAVA, AURORA, CO (US); BART WILLIAM LANTZ, BOULDER, CO (US); RICHARD ALAN SMITH, LAFAYETTE, CO (US); GREGORY S. LEMS, LAFAYETTE, CO (US); GLYNNE F. CASTEEL, LAFAYETTE, CO (US); ROGER MARC DELISLE, OTTAWA (CA); JAMES DAVID MCELHINEY, OTTAWA (CA); DANIEL JOHN CARLOS MURRAY, MOUNTAIN (CA)

Correspondence Address: JAMES R. YOUNG, CHRISMAN, BYNUM & JOHNSON, PC, 1900 FIFTEENTH STREET, BOULDER, CO, 80302

(21) Appl. No.: 09/181,955

(22) Filed: Oct. 28, 1998

(51) Int. Cl. G06F 15/173; G06F 15/16

(52) U.S. Cl. 709/224; 709/203

(57) ABSTRACT

An apparatus and method for determining transfer time and/or bandwidth between devices connected to a computer network includes sending a script or redirect signal to a browser attempting to fetch a banner from a server that causes a timer or clock to run between the initiation of a subsequent fetch page, fetch image, or other request by the browser and the delivery of subsequent data to the browser. The bandwidth of the device and/or the transfer time between the server and the device on which the browser is operating and the bandwidth of the device can then be used in the selection of which subsequent files, images, scripts, banners, executable software, or other content to be served to the browser or in the selection or configuration of web pages, electronic mail, or executable software to be served to the browser. In addition, the operational or performance characteristics or configuration of the device on which the browser is operating can also be determined and used during the selection of which subsequent files, images, banners, executable software or other content to be served to the browser or in the selection or configuration of web pages, electronic mail, or executable software to be served to the browser.

### CROSS REFERENCE TO RELATED PATENT APPLICATION

This patent application is a continuation of copending U.S. patent application Ser. No. ______, filed in the U.S. Patent and Trademark Office on Oct. 27, 1998.

### BACKGROUND OF THE INVENTION

1. Field of the Invention

This invention relates to an apparatus and method for determining transfer time and bandwidth for a data file sent via a computer network and, more specifically, to an apparatus and method for selecting a data file to be sent via the computer network as a function of the transfer time or bandwidth between two devices connected to the computer network and for selecting or dynamically customizing content provided to a client connected to the computer network based on the transfer time and bandwidth determinations.

2. Description of the Prior Art

During recent years there have been rapid advancements in computers and computer networking. In particular, the world-wide networks of computers, servers, hosts, and other devices commonly referred to as the Internet and the World Wide Web have seen rapid growth. The Internet comprises a vast network of smaller wide area networks, local area networks, intranets, etc. connected together so as to allow sharing of resources and to facilitate data communication and information exchange between users, computers, servers, hosts, and other devices. The rapid growth of the Internet is due, in large part, to the development and widespread use of graphical user interfaces, called browsers, which allow users easy access to the computers, servers, hosts, and other devices connected to the Internet and, more particularly, the World Wide Web.

The World Wide Web forms a subset of the Internet and includes a collection of networked servers, computers, and other devices. Each server may contain documents formatted as web pages or hypertext documents that are accessible and viewable with a web compliant browser, such as the Netscape navigator browser or the mosaic browser. Each hypertext document or web page may contain references to graphic files or banners that are to be displayed in conjunction with the hypertext document or web page. The files and banners may or may not be stored at the same location as the hypertext document or web page.

A hypertext document often contains hypertext links to other hypertext documents such that other hypertext documents can be accessed from the first hypertext document by activating the hypertext links. The servers connected to the World Wide Web utilize the Hypertext Transfer Protocol (HTTP) which is widely known protocol which allows users to use browsers to access web pages and banners or files associated with web pages. For purposes of the present invention, the term “banner” is meant to be construed very broadly and includes any information displayed in conjunction with a web page wherein the information is not part of the same file as the web page. That is, a banner includes anything that is displayed or used in conjunction with a web page, but which can exist separately from the web page or which can be used in conjunction with many web pages. Banners can include graphics, textual information, video, audio, applets, animation, rich media, SCRIPT (such as JavaScript and VBSCRIPT), IFRAME requests (which may contain JavaScript content or requests), Flash, Shockwave, Enliven, and links to other computer sites, web sites, web pages, or banners. The files, banners, hypertext documents, or web pages may contain text, graphics, images, sound, video, etc. and are generally written in a standard page or hypertext document description language known as the Hypertext Markup Language (HTML). The HTML format allows a web page developer to specify the location and presentation of the graphic, textual, sound, etc. on the screen displayed to the user accessing the web page. In addition, the HTML format allows a web page to contain links, such as the hypertext links described above, to other web pages or servers on the Internet. Simply by selecting a link, a user can be transferred to the new web page, which may be located very different geographically or topologically from the original web page.

When using a conventional browser, a user can select which web page or hypertext document the user wishes to have displayed on the user's computer or terminal by specifying the web page's Universal or Uniform Resource Locator (URL) address. Each server has a unique URL address and, in fact, so does each web page and each file needed to display the web page. For example, the URL address for the U.S. Patent and Trademark Office is currently http://www.uspto.gov. When a user types in this URL address into a browser, the user's computer establishes a connection with the U.S. Patent and Trademark Office and the initial web page for the U.S. Patent and Trademark Office is transmitted from the server storing this web page (which may or may not be actually located at the U.S. Patent and Trademark Office) to the user's computer and displayed on the user's computer. The web page may include a number of graphic images or elements, often referred to as banners, which are to be displayed on the user's computer in conjunction with the web page. Each of the graphic images is typically stored as a separate file on the server and has its own URL address. When the web page is initially transmitted or served from the server to the user's computer, the browser receives the URL addresses for the graphic images and then requests that they be transmitted or served from the server on which they are stored to the user's computer for display on the user's computer in conjunction with the web page. Thus, the browser “fetches” the images for display on the user's terminal or computer. The server(s) on which the graphic images are stored may or may not be the same server on which the original web page is stored. More specifically, since the URL's addresses for the included graphic images are all processed separately using the HTML protocols, it is possible and, in fact, common, for these graphic images to be stored on separate and even widely distributed computers or hosts, all of which are accessible to the user's computer via a computer network.

The growth of easy access to the World Wide Web and the ability to create visually pleasing web pages have helped increase the amount of advertising and other promotional materials created for use and display with web pages. For example, a car manufacturer may have a web page describing the company and the cars and car parts that the company manufactures and sells. Part of the web page may include advertising information or banners such as, for example, images of current car models sold by the manufacturer or the types and numbers or cars the manufacturer has in stock. The car manufacturer may also contract with the owners or operators of other web pages to have the car manufacturer's advertisement banners displayed when users access these other web pages. Similarly, an advertising agency may contract with various web sites to have the advertisement banners of the agency's clients displayed when users access the web pages stored on the web sites. For example, an advertising agency or ad-network firm may contract with a web site containing general information about cars to have advertising information or banners included on the web pages displayed to a user accessing the web site. The advertising banners may contain graphics, text, etc. about car models or car parts manufactured by on of the advertising agency's clients. Furthermore, the advertisement banners may not be stored on the same server or computer or web site on which the web page is stored. Rather, all or a significant portion of the advertisement banners created by an advertising agency may reside on one or more information servers, ad selection servers, or media servers. Typically, an advertising agency will pay a fixed amount of money for a fixed number of displays of its advertisement banners on a single web page or group of web pages.

In general, an ad selection server is a configurable server that accepts requests for web content (images, HTML web pages, logic files, etc.), performs ad selection, and returns an instruction to the requesting client to retrieve specific content elsewhere, perhaps from a media server. A media server is a high speed server of content, but does not usually perform ad selection. An information server is a broad term used to describe servers on which information, web pages, content, etc. is stored.

In a typical ad serving environment, the web page requested or fetched by a user's browser from a web page server will contain banners for display with the web page. Instead of providing the banners, the web page served to the user' browser will contain links to one or more ad selection servers related to the banners. Upon receipt of the web page, the user's browser will then request or follow the links and request the banners from the ad selection servers. The ad selection servers will decide which banner to serve in response to each request and will either server the requested banner, or serve the user's browser with a redirect signal or command telling the user's browser where to find the banner. Typically, the banners will be located on a media server. The user's browser will then send a request to the media server requesting that the banner be served from the media server to the user's browser. Thus, when a user views a web page displayed on the user's computer, the user's browser page may request or “fetch” advertisement banners for display on the web page. Since the user may only spend a few minutes, or even seconds, actually looking at any particular advertisement banner or any particular web page displayed on the user's computer, if too long a period of time is taken before an advertisement banner is served to the user's computer for display to the user, the user may request or select that a different web page be fetched and served to the user's computer for display before the advertising banner is completely received by the user's computer or displayed to the user.

Advertisers generally prefer that a complete advertisement be displayed to a user before the user selects or fetches a new web page for display. Therefore, advertisers may desire to send advertisement banners that have different sizes or formats depending on the connection or transfer time between a user's computer and the server that is serving or delivering the advertisement banners to the user's computer. If the transfer time, also referred to as the travel time or load time, between the server serving the advertisement banner and the user's computer is too long, the advertiser may wish to serve a smaller advertisement banner to reduce the amount of time before the smaller advertisement banner is fully displayed to the user. The smaller advertisement banner could, for example, have a size of four kilobytes. In contrast, if the time it takes to transfer the advertisement banner from the server to the user's computer is short, the advertiser may wish to serve a larger advertisement banner since the larger advertisement banner is likely to be fully displayed to the user before the user selects or fetches a new web page. The larger advertisement banner could, for example, have a size of forty kilobytes or possibly even many megabytes. Rich media, which is commonly viewed as any content other than HTML formatted text, still images, animated images in GIF or JPG graphics format, or other simple media are a common type of banner, image, or file which may be sent to a user's computer. Many advertisers displaying advertisement banners on web sites, or web sites themselves, will not accept rich media or allow rich media to be used because the sheer size (often over forty kilobytes) will compromise the user's experience, thereby causing the user to reject or avoid the web site in the future. The user may not know that the cause of the slow performance is not the web site itself, but the use of the rich media. Therefore, web sites and advertisers will often try for the smallest page or banner size possible to insure that users with the slowest links or transfer time to the web site will still receive reasonable performance. However, such a decision is at the expense of users with shorter transfer times, often created by higher bandwidth, that could handle the rich media without a significant or noticeable change in performance.

The determination of what size or type advertisement banner should be served to the user can be made, in whole or in part, on how long a period of time is required to send a file between the server and the user's computer. Thus, determining the transfer time between a user's computer and a server or the user's bandwidth can be very important in effective on-line advertising.

Unfortunately, the current state of the art is such that determination of transfer time between user's computers or terminals and servers can be difficult, particularly since network topologies, including the network topologies of the Internet and the World Wide Web, change constantly. In addition, transfer times for a computer network may vary over time due to variations or fluctuations in the number of users actively connected to the computer network, variations or fluctuations in the amount of data traffic or data communication over the computer network, variations or fluctuations in availability of parts or all of the computer network, etc. Therefore, despite the well developed state of the art in computer networking, there remains a need for accurately determining the transfer time between two devices connected to a computer network and the bandwidth for users connected to a computer network. Preferably, determinations could also be made regarding the bandwidth or topology between two devices connected to a computer network and regarding the operational or performance characteristics or configuration of devices connected to the computer network.

### SUMMARY OF THE INVENTION

Accordingly, it is an object of the present invention to provide an apparatus and method for determining transfer time between two points on a computer network.

It is another object of the present invention to provide an apparatus and method for selecting banners to be served via a computer network.

Yet another object of the present invention is to provide an apparatus and method for collecting information regarding bandwidth of portions of a computer network.

Another object of the present invention is to provide an apparatus and method for determining bandwidth between two devices or for a device connected to a computer network.

It is a further object of the present invention to provide an apparatus and method for collecting information regarding a computer network's topology.

It is another object of the present invention to provide an apparatus and method for monitoring bandwidth between two devices or for a device connected to a computer network and computing such bandwidth in real time.

Another general object of the present invention is to provide an apparatus and method for computing bandwidth for a device or between two devices connected to a computer network and providing such information for use during selection and/or configuration of web pages, content, executable software, email, etc. to be served to a user or a user's browser.

Still another object of the present invention is to provide an apparatus and method for determining information regarding the operational or performance characteristics or configuration of devices connected to a computer network.

Additional objects, advantages, and novel features of the invention shall be set forth in part in the description that follows, and in part will become apparent to those skilled in the art upon examination of the following or may be learned by the practice of the invention. The objects and the advantages may be realized and attained by means of the instrumentality's and in combinations particularly pointed out in the appended claims.

To achieve the foregoing and other objects and in accordance with the purposes of the present invention, as embodied and broadly described herein, a method for distributing information over a computer network to a device includes sending a page request signal from the device to a first server requesting that a page be served to the device; serving said requested page to said device, wherein said page includes location information for a portion of executable software located on a second server; sending a request signal from said device to said second server requesting that said executable software be served to said device; serving said requested executable software to said device; executing said executable software; sending an image request signal from said device for an image; and serving said requested image to said device.

In addition to the above, in another embodiment, in order to achieve the foregoing and other objects and in accordance with the purposes of the present invention, as embodied and broadly described herein, a method for determining transfer time between a computer and a first server connected to a computer network includes serving a piece of information from the first server to the computer, wherein said piece of information contains executable software; executing said executable software on the computer; sending an image request from the computer to the first server requesting a location address for an image to be served to the computer; and serving said image to said computer as a result of said image request signal.

In addition to the above, in another embodiment, in order to achieve the foregoing and other objects and in accordance with the purposes of the present invention, as embodied and broadly described herein, a method for delivering information over a computer network to a computer includes serving a piece of information from a first server to the computer, wherein said piece of information includes location information for an image; sending a first image request from the computer; serving a redirect signal to the computer in response to said first image request; sending a second image request from the computer; and serving said second image to said computer.

In addition to the above, in another embodiment, in order to achieve the foregoing and other objects and in accordance with the purposes of the present invention, as embodied and broadly described herein, a method for delivering information over a computer network to a computer includes serving a piece of information from a first server to the computer, wherein said piece of information includes location information for an image; sending a first image request from the computer; serving a first redirect signal to the computer in response to said first image request; sending a second image request from the computer; serving a second redirect signal to the computer in response to said second image request; sending a third image request from the computer; and serving said third image to said computer.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

In the Drawings

FIG. 1 illustrates a computer network upon which computers, terminals, servers, hosts, etc. can be connected;

FIG. 2 illustrates a flowchart for a first embodiment of a method in accordance with the present invention that can be used with the computer network of FIG. 1;

FIG. 3 illustrates a flowchart for a second embodiment of a method in accordance with the present invention that can be used with the computer network of FIG. 1; and

FIG. 4 illustrates a flowchart for a third embodiment of a method in accordance with the present invention that can be used with the computer network of FIG. 1.

### DETAILED DESCRIPTION OF THE PREFERRED EMBODIMENTS

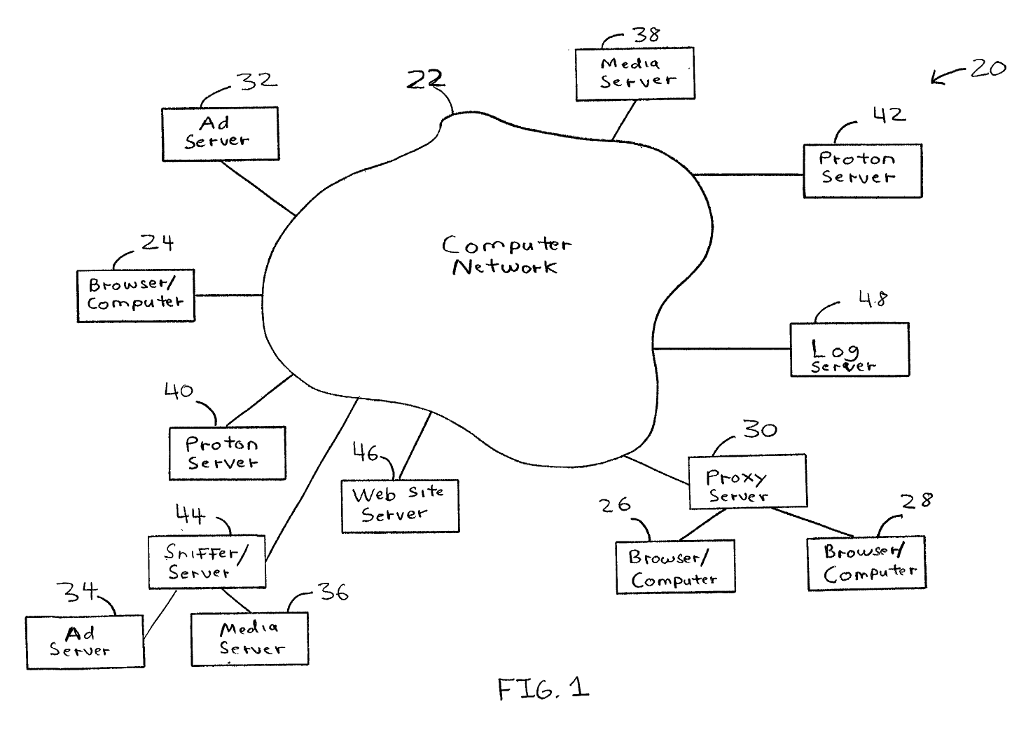

A network apparatus 20 in accordance with the present invention is illustrated in FIG. 1 and includes a computer network 22 to which devices such as the computers 24, 26, 28, proxy server 30, ad selection servers 32, 34, media servers 36, 38, proton servers 40, 42, sniffer server 44, web site server 46, and log server or log processing system 48 are connected to allow for resource sharing and data communications. Users located at computers or terminals 24, 26, 28 can access or connect to the computer network 22 and the resources connected to the computer network 22. Computers, such as the computer 24, may be directly connected to the computer network 22. Other computers, such as the computers 26, 28, may be connected to the computer network 22 via a proxy server, such as the proxy server 30.

A significant feature of the present invention is the ability to determine transfer time for data, files, etc. sent or transmitted between devices connected to a computer network and the bandwidth between the devices, and the bandwidth for users connected to the computer network. For example, with the apparatus and method of the present invention, the transfer time for a file to be sent from the ad selection server 32 or the media server 38 to the computer 24 via the computer network 22 can be determined and used in the selection or configuration of files, banners, content, web pages, executable software, email, images, etc. to be delivered or served to the computer 24. Bandwidth is a measure of how fast a connection is between devices connected to the computer network and can be related to the transfer time, as will be discussed in more detail below.

By being to determine or monitor transfer time and bandwidth in real time or near real time, or by at least monitoring available bandwidth (including “effective bandwidth”) between a user and other devices connected to a computer network, web browsing satisfaction can be increased for the users while advertising over the computer network can be dynamically modified or created, thereby improving the effectiveness of the advertising. Thus, high-bandwidth users will get sophisticated rich media content, while lower band-width users will get quicker content downloads from servers. The content selected can be and delivered to a user can be, for example, a black and white image for a low-bandwidth user (e.g., a user connected to a computer network via a 14.4 Kbps modem), a color version of the same image for an average bandwidth user (e.g., a user connected to the computer network via a 28.8 Kbps modem), or an animated or video version for a high-bandwidth user (e.g., a user connected to the computer network via an ISDN or T1 connection). A user's bandwidth may vary over time due to, for example, telephone line noise, the number of users, changes in browser type, etc. Real time or near real time determination of a user's bandwidth or transfer time between the user and another device on the computer network allows selection or dynamic adjustment of the types of images, ads, content, web pages, software, email, etc. to serve or send the user.

Another significant feature of the present invention is the ability to determine operational and performance characteristics or configurations of devices connected to a computer network. For example, such operational and performance characteristics or configuration might be determinable for the computer 24 or the computer 26 and used in the selection or configuration of files, banners, images, content, executable software, email, etc. to be delivered or served to the computer 24 or the computer 26.

The computer network 22 and the network apparatus 20 illustrated in FIG. 1 are only meant to be generally representative of computer or data communication networks for purposes of elaboration and explanation of the present invention and other devices, networks, etc. may be connected to the computer network 22 without departing from the scope of the present invention. The computer network 22 is also intended to be representative of, and include all or a part of, the Internet, the World Wide Web, and other privately or publicly operated networks. The computer network 22 can also include other public and/or private wide area networks, local area networks, data communication networks or connections, intranets, routers, satellite links, microwave links, cable connections, cellular or radio links, fiber optic transmission lines, ISDN lines, TI lines, etc. It should be noted that the distinction between ad selection servers, web site server, media servers, proton servers, sniffer servers, proxy servers, log servers, information servers, etc. is made only for the purposes of elaboration and explanation, but not limitation, of the present invention. Thus, a device can function simultaneously or alternatively as one or more of these devices without falling outside the scope of the present invention. In addition, as used herein, the terms “computer” and “client” are generally interchangeable and are meant to be construed broadly and to include, but not be limited to, all clients, client devices or machines, terminals, computers, processors, servers, etc. connected or connectable to a computer or data communications network and all devices on which Internet-enabled software, such as the Netscape Communicator™ or Navigator™ browsers, Mosiac™ browser, or Microsoft Internet Explorer™ browser, can operate or be run. The term “browser” should also be interpreted as including Internet-enabled software and computer or client software that enables or allows communication over a computer network and Internet-enabled, monitored, or controlled devices such as WebTV, household appliances, phones, etc.

Proton servers, such as the proton servers 40, 42, are generally described as, or meant to include, distributed databases residing servers in or on which information or data about users is stored. These servers provide data to systems, such as ad selection servers, and allow those systems to view, use, and add user information and data. Periodically, proton servers connected to a computer network will update each other with all new data, thereby resulting in synchronized data and redundant database servers.

Media servers, such as the media server 38, are generally described as, or meant to include, high speed World Wide Web servers of content, such as HTML Web page files, images, and logic files. Media servers may log user activity, but usually they do not perform ad selection. In addition, media servers may populate proton servers or otherwise provide proton servers with user data.

Ad selection servers, such as the ad selection server 32, are generally described as, or meant to include, intelligent, configurable, World Wide Web servers that accept requests from clients for Web content, such as HTML Web page files, images, logic files, etc., perform ad selection, and return a redirect instruction to the clients to retrieve the specifically selected content from another server, usually a media server. Ad selection servers may serve content to clients as well as providing a redirect instruction. In addition, ad selection servers may log user activity and populate proton servers or otherwise provide proton servers with user data.

A sniffer, such as the sniffer server 44, is generally described as, or meant to include, a system that monitors network traffic and, for each transaction, associates the first data packet and the corresponding last data packet, noting the elapsed time, total data transferred (in bytes), and the user's unique identifier (possibly the identifier cookie value and possibly the Internet Protocol (IP) address of the client software for the transaction being observed). Sniffers usually log or store their data for post-processing and may populate proton servers or otherwise provide proton servers with user data.

By way of general introduction, in a typical computer network, a user located at a computer or terminal can access the resources connected to the computer network. For example, a user at the computer or terminal 24 or the computer or terminal 26 can access the web site server 46 and the information stored thereon. The web site or server 46 may contain web pages that the user can download for display on the computer 24. For purposes of this invention, the term “web page” shall be defined broadly and will include any hypertext document, information, screen displays, etc. that a user can download or otherwise retrieve from a computer or web site for display and/or storage on the user's terminal, and shall not be limited to only the information, pages, or documents retrievable by a user connected to the World Wide Web. Therefore, the term “web page” will be used generically to refer to information transmitted or served to a terminal from a computer site, web site, server, or other device, wherein the web page may contain banners or references to banners that can be served to the terminal and displayed in conjunction with the web page. The web page served to the user's computer from the web site server 46 may contain textual information and information configured in banners or other content. The banners or content may contain graphics, rich media, audio, graphics, IFRAMES references, Java, JavaScript, VBSCRIPT, and other SCRIPT, applets, text, video, etc. As previously discussed above, the banners or other content associated with a web page may not be stored at or on the same place or server as the web page and may be downloaded or served to a user's computer separately from the web page. That is, web pages may be stored on a web page server while the banners or other content are stored on ad selection servers or media servers.

For purposes of elaboration and explanation of the present invention, the conventions and protocols of the World Wide Web, and browsers therefore, will be used as examples, in particular, the concept of a Uniform Resource Locator (URL), the Hypertext Transfer Protocol (HTTP), the Hypertext Markup Language (HTML), and the Transmission Control Protocol/Internet Protocol (TCP/IP). In addition, the principles and conventions for rich media such as scripts (including JavaScript and VBSCRIPT), dynamically executed content such as Java Applets and ActiveX controls, and imported, nested, or externally referenced content (for example, content using the “IFRAME” tag) will also used. It should be noted, however, that the concepts underlying the present invention can be used for computer networks using other or different types of conventions and protocols. For more details on these protocols and software languages, the reader is directed to: Kevin Washburn and Jim Evans, TCP/IP running a successful network, 2nd Ed. (1996), published by Addison-Wesley; Douglas E. Comer, Internetworking with TCP/IP, 3rd Ed. (1995), published by Prentice Hall; John December and Mark Ginsberg, HTML 3.2 and CGI Unleashed Professional Reference Edition (1996), published by Sams.net Publishing; Jerry Honeycutt et al., Using HTML 3.2, 3rd Ed (1997), published by Que Corporation; and John December, Presenting Java, An Introduction to Java and HotJava (1995), published by Sams.net Publishing, all of these references of which are incorporated herein by reference. Other information about the HTTP, HTML, TCP/IP and other network protocols can also be found in U.S. Pat. No. 5,617,540 issued to Civanlar et al., U.S. Pat. No. 5,572,643 issued to Judson, and U.S. Pat. No. 5,442,771 issued to Filepp et al., all of which are also incorporated herein by reference. The linking of one web page or hypertext document to another is commonly done using a hypertext markup comment tag. When the user clicks on or otherwise activates the hypertext markup comment tag, a link to the new web page or hypertext document is generally initiated by the user's browser software which causes the user's browser to request that the new web page or hypertext document be displayed on the user's computer. Similarly, if a web page served to a user's computer contains references to banners or other content, the URL addresses for the banners and other content will be served with the web page so that the user's browser can request that the banners or content be served to the browser for display on the user's computer along with the previously served web page.

It should also be noted that the disclosed system and method also work for all types of operating systems running on the computers, terminals, computer sites, information servers, and other devices connected to the computer network 22. Such operating systems can include, for example, Microsoft's DOS™, WINDOWS 3.x™, WINDOWS NT™, WINDOWS 95™, or WINDOWS 98™ software, IBM's OS/2™ software, Apple's System 7™ software, or the AIX or UNIX operating system software platforms.

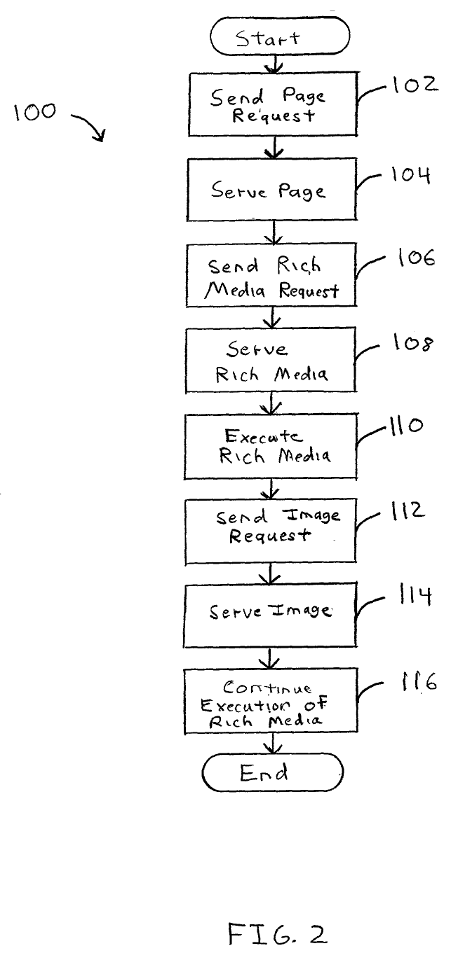

As previously discussed above, the methods of the present invention are primarily directed to determining transfer time between devices connected to a computer network and the bandwidth of a user connected to a computer network, such as the computer network 22. Optional steps may also be included and many such optional steps will be discussed in more detail below. Now referring to FIG. 2, a first embodiment of a method designed in accordance with the principles of the present invention will now be described in more detail. The method 100 for determining transfer time and user bandwidth is preferably used for determining transfer time or available bandwidth for data, files, banners, images, content, email, executable software, etc. sent between a server, such as the ad selection server 32 or the media server 38, and a computer, such as the computer 24, on which browser software is operating. In addition, the method 100 is preferably used for browsers capable of supporting, operating, or running rich media, such as SCRIPT (e.g., VBSCRIPT or JavaScript), an IFRAME usage or request, nested HTML files, Flash, Shockwave, or Enliven, or some portion of executable script, code, or software.

During the method 100, a user's browser, for example the browser operating on the computer 24, sends or initiates a fetch web page request during step 102 to a web site server, such as the server 46, that requests that the web site server send or serve a web page to the user's browser. Such a fetch web page command or request generated by the user's browser during the step 102 might take the form of, for example, http://www.excite.com/WebPage1.html. The web site server to which the fetch web page request is sent during the step 102 will then serve or send the desired web page to the user's browser during step 104. The web page sent or served to the user's browser during step 104 will include a link or reference to a rich media file, such as a SCRIPT (e.g., JavaScript, VBSCRIPT) or an IFRAME reference to be fetched by the user's browser during step 106. The rich media file may or may not be located on the same server or device as the original web page fetched or requested by the user's browser during the step 102. For example, the web page fetched or requested by the user's browser during the step 102 may be located on the server 46 while the rich media file fetched by the user's browser during the step 106 may be located on the server 46, the ad selection server 32, the media server 38, or some other device connected to the computer network 22. For purposes of further explanation, but not limitation, of the method 100, the rich media file will be assumed to be stored on or located at the ad selection server 32.

Upon receipt by the user's browser of the desired web page served during the step 104, the user's browser will send or initiate a fetch rich media request during the step 106. Such a fetch rich media command or request generated by the user's browser during the step 106 might take the form of, for example:

<IFRAME WIDTH=468 HEIGHT=60

SRC=“http://ad.preferences.com/iframe;spacedesc=Campaign1_Site1_{—}468×60_Package1 _Location1”>

<SCRIPT>

SRC=“http://ad.preferences.com/jscript;spacedesc=Campaign1_Site1_{—}468×60_Package1 _Location1 ”>

</SCRIPT>

<NOSCRIPT>

<A

HREF=“http://ad.preferences.com/click;spacedesc=Campaign1_Site1_{—}468×60_Package1 _Location1”>

<IMG

SRC=“http://ad.preferences.com/image;spacedesc=Campaign1_Site1_{—}468×60_Package1 _Location1 ”>

</A>

</NOSCRIPT>

</IFRAME>

Note that the previous rich media request example includes both an IFRAME reference and a reference to JavaScript for purposes of explanation. A rich media request does not have to have both such references. Upon receipt of the rich media request generated by the user's browser, the ad selection server 32 will serve or send the requested rich media to the user's browser during step 108.

Upon receipt of the rich media requested or fetched by the user's browser during the step 102 and served or sent by the ad selection server 32 during the step 108, the user's browser will run or initiate the rich media during step 110. The rich media may take many forms and include many commands or portions of executable software or code. For example, the rich media may include JavaScript, VBSCRIPT, or an IFRAME (inline frame) reference that causes the user's computer to perform a specified function or operation a specified number of times and also causes the user's computer to monitor the amount of time the computer takes to perform such specified function the specified number of times. From this time measurement, the computational speed of the user's computer might be ascertained or approximated. An example function might be the following:

var tmCurrentTime=(new Date()).getTime();.

The script included within the rich media might cause the user's computer to execute such a function one thousand or one million times and record the time taken by the user's computer to complete the task. Scripts, such as JavaScript and VBSCRIPT, are well known to people of ordinary skill in the art and they need not be described in any further detail for purposes of explanation of the apparatus and method of the present invention.

The rich media served to the user's browser during the step 108, upon execution by the user's browser during step 110, may also start a clock or timer or, at least note the current time, and, during the step 112, cause the user's browser to fetch or request an image by sending a fetch image request. Such a fetch image request sent by the user's browser during the step 112 could take the form of, for example:

http://ad.preferences.com/image;spacedesc=Campaign1_Site1_{—}468×60_Package1_Location1.

Representative JavaScript for implementing such a series of commands is provided below.

The image requested or fetched by the user's browser during the step 112 may or may not be located on the same server or device as the original web page fetched or requested by the user's browser during the step 102 and may or may be located on the same server or device as the rich media file requested or fetched by the user's browser during the step 106. For example, the web page fetched or requested by the user's browser during the step 102 may be located on the server 46 while the rich media file fetched or requested by the user's browser during the step 106 may be located on the server 46, the ad selection server 32, the media server 38, or some other device connected to the computer network 22. In addition, the image fetched or requested by the user's browser during the step 112 may also be located on the server 46, the ad selection server 32, the media server 38, or some device connected to the computer network 22. For purposes of further explanation, but not limitation, of the method 100, the image fetched or requested by the user's browser during the step 112 will be assumed to be stored on or located at the ad selection server 32.

After the ad selection server 32 receives the fetch image request generated by the user's browser during the step 112, the ad selection server 32 will serve or send the requested image to the user's browser during step 114. The rich media file or script preferably initiated or executed during the step 110 preferably will, upon receipt by the user's browser of the image sent or served during the step 114, cause the timer or clock previously started by the rich media file during the step 110 above to stop during step 116. Alternatively, during step 116, the rich media or script may cause the user's browser to simply note the time at which the image is received by the user's browser. Therefore, the total time elapsed between the execution of step 112, i.e., the sending by the user's browser of a fetch image request, and the receipt by the user's browser of the image served during the step 114 is measured. This measured time will closely approximate the round trip transfer time between the user's computer or browser and the server from which the image served during the step 114 was served (the media server 38 in this example). From this round trip transfer time, the user's bandwidth (including effective bandwidth) can be determined. The steps 114, 116 may be considered as a single step and not as completely independent steps. For example, the rich media executed during step 114 may be the same rich media executing during step 116. The step 116 is essentially optional and is illustrated primarily for explanation of the method 100.

In general, the user's bandwidth of the currently available bandwidth (in bytes per second) between the server and the user's computer can be determined from the transfer time by dividing the number of bytes transferred by the elapsed transfer time in seconds.

In a more specific implementation, user bandwidth can often be determined from the file size transferred between a user and a server and the transfer or load time for the transfer of the file. A problem for users connected to a computer network is latency, which can be defined as the delay between the time a user requests content and the time the user starts to receive that content. High latency may occur in users connected in remote locations to a computer network and/or when communications problems cause the “route” of a connection in the computer network to go through many relay stations including multiple orbiting satellites. Other causes can be business-related, such as the user who is connected to an ISP (Internet Service Provider) who, in turn, is connected to another ISP (and possibly others) before the communications can travel at high speeds on a computer network, such as the “Internet backbone.”

The major factors contributing to a user's low effective bandwidth are the use of a slow modem and high demand on the computer network, such as the Internet, to which the user is connected. Other causes can be: the user's ISP has slow modems, poor telephone connections from user's modem to the phone company's central office, or any combination of those factors.

If a user's browser is connected to a computer network, such as the Internet, through a fast connection and is close to a server (in geographic proximity), the transfer time between the user's browser and the server of a small amount of data (e.g., one hundred bytes) will appear small (e.g., twenty milliseconds). If a larger amount of data (e.g., one thousand bytes) is transferred from the same server to the same user, the transfer time will be greater (e.g., one hundred and ten milliseconds). In this example, the latency could be determined to be low (e.g., ten milliseconds) and the user's bandwidth to be high (e.g., ten thousand bytes per second).

If the user is connected to the computer network through a slow connection and is close to the server, the transfer time between the user's browser and the server of a small amount of data (e.g., one hundred bytes) might appear somewhat small (e.g., one hundred and thirty milliseconds). If a large amount of data (e.g., one thousand bytes) is transferred between the server and the user's browser, the transfer time will be much greater (e.g., one thousand and thirty milliseconds). In this example, the latency could be determined to be somewhat low (e.g., thirty milliseconds) and the user's bandwidth to be low (e.g., one thousand bytes per second).

If the user is connected through a high speed connection to a server, but a great distance from the server, the transfer time between the user's browser and the server of a small amount of data (e.g., one hundred bytes) will appear somewhat larger (e.g., one thousand and ten milliseconds). Transfer of a large amount of data (eg: one thousand bytes) may seem to take only slightly longer (e.g., one thousand and one hundred milliseconds). In this example, the latency could be determined to be very high (e.g., one thousand milliseconds) and the user's bandwidth to be high (e.g., ten thousand bytes per second).

Lastly, if a user has a slow modem and, therefore, a slow connect to the computer network, and the user is a great distance from the server, the transfer time between the user's browser and the server of a small amount of data (e.g., one hundred bytes) will appear very large (e.g., fourteen hundred milliseconds). If a large amount of data (e.g., one thousand bytes) is transferred, the transfer time will be even greater (e.g., twenty-three hundred milliseconds). In this example, the latency could be determined to be high (e.g., thirteen hundred milliseconds) and the user's bandwidth to be low (e.g., one thousand bytes per second).

The following formula is suggested as a basis for this analysis: (Bytes transferred * (1/Bytes per millisecond) * K_{bw1})+K_{bw2}+(Latency * K_{L1})+K_{L2}=Round Trip Time (in milliseconds) where K_{bw1}, K_{bw2}, K_{L1}, and K_{L2} are adjustment constants and factors. More specifically, K_{Bw1} is a calibration factor constant for applied to affect bandwidth, K_{Bw2} is a calibration additive constant applied to affect bandwidth, K_{L1} is a calibration factor constant applied to affect latency, and K_{L2} is a calibration additive constant applied to affect latency. Calibration and determination of these constants must be done with clients with a known proximity to servers and known transfer speeds to determine actual bandwidth and latency constants to determine the values for K_{bw1}, K_{bw2}, K_{L1}, and K_{L2}.

Once the transfer time and/or bandwidth (the term “bandwidth shall also encompass the concept of “effective bandwidth”), between a user's computer and a server are determined, additional content to be sent or served from a server to the user's computer or browser may be selected, or not selected, if the transfer time between the server and the user's computer is too long or if the user's bandwidth is insufficient to allow delivery of large images, such as rich media, within a specified period of time. If the transfer time between the server and the user's computer is short enough or the user's bandwidth for the connection between the server and the user's computer is large enough, the user may be connected via a high bandwidth network to the server. Therefore, rich media files may be sent to the user's computer without requiring significant amounts of time. In contrast, if the transfer time between the server and the user's computer is sufficiently long or the bandwidth for the connection between the user's computer and the server is too small, the user may be connected via a low bandwidth network to the server. Therefore, it may be preferable to send only smaller files in response to image request signals generated by the user's browser.

During the step 116, the user's browser may also optionally request that content be served to the user's browser. In addition, the user's browser may optionally send or transmit the transfer time and user bandwidth information and other information regarding the operational or performance characteristics or configuration of the user's computer to another computer, server, or other device connected to the computer network 22. For example, the user's browser may send or transmit the information to the log server 48, the proton servers 40, 42, the ad selection server 32, the media server 38, a log file, or a profile repository. The user's browser may also include such information in a cookie or other information or data file stored on the user's computer. The user's browser may also send other information such as, for example, information related to the time/date that the transfer time was determined, the type or size of the file or image used to determine the transfer time and/or bandwidth, cookie information, or other user related information (type of browsers, operating system, computer configuration, etc.). During subsequent requests by the user's browser for content (which may be initiated by the rich media), an ad selection server deciding which ad or content to be served to the user might request or use the stored information regarding the user's bandwidth to select the ad or content to be served to the user. For example, if the ad selection server 32 is deciding which ad to serve the user located at the computer or terminal 24 after receiving a content request from the user's browser, the ad selection server 32 may query the proton server 40 or view a cookie, if any, sent with the content request to see if the bandwidth information for the user has already been determined. If the bandwidth information for the user has been determined, the ad selection server 32 can use the information to determine which ad or piece of content is to be served to the user's browser. If no user information exists, the ad selection server might implement the method 100 to gather and store the user information in the proton server 40, a log file, a profile repository, or on the user's computer for further use. The user bandwidth and transfer time information might also be used for selecting between available executable software or applications to be served or sent to user and during dynamic configuration of executable software prior to or after being served to a user.

It should also be noted that the rich media file or script executed or commenced during the step 110 may be initiating or causing the user's browser or compute to perform other functions prior to the step 116 or before, during, and after the step 114. For example, during the step 116, the rich media script may also cause the user's browser to fetch or request other images so that transfer time and/or the user's bandwidth between the user's computer and other devices connected to the computer network 22 may be determined. Such additional requested images may be of various file or packet sizes to allow for transfer times various sizes or types of images or files to be determined, stored in a cookie or proton server, or used for content or ad selection, web page configuration, or other purposes. During the step 116, the rich media may initiate or run one or more nested sequences of one or more steps in the method 110 or initiate a request for content to be served to the user's browser.

During implementation of the method 100 in an on-line advertising campaign, additional steps may be added where the advertisement, advertising banner or other content selected to be served to a user connected to a computer network is based, at least in part, on the user's bandwidth or transfer time between the server from which the advertisement or advertising banner will be served and the user's computer or browser to which the advertisement, advertising banner, or other content will be served. Representative JavaScript for implementing such a series of commands is provided below. In addition, a representative implementation of the method 100 in an ad serving context is also described below.

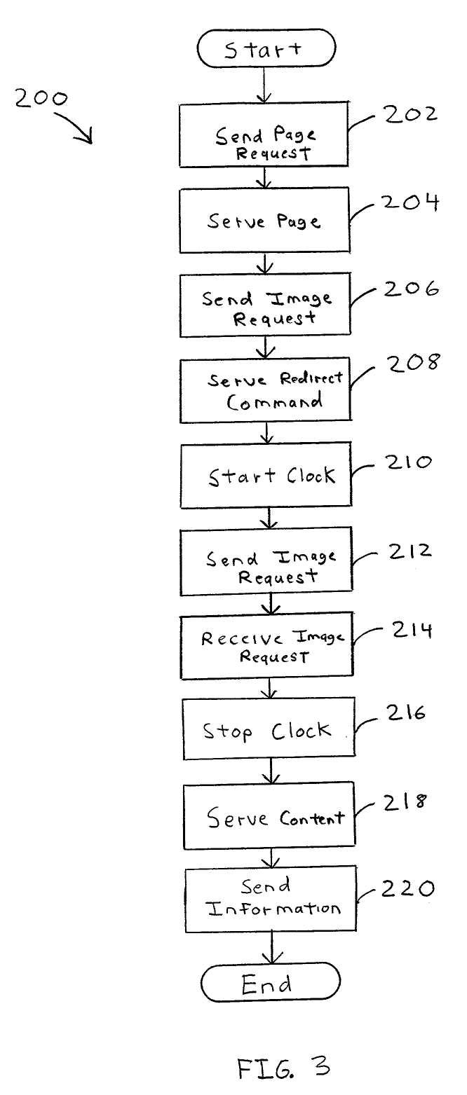

A second embodiment 200 of a method designed in accordance with the principles of the present invention is illustrated in FIG. 3. While the method 200 is useful for determining transfer time and/or user bandwidth for data, email, executable software, web pages, files, banners, images, and other content etc. selected, configured, and sent between a server, such as the ad selection server 32 or the media server 38, and a computer, such as the computer 24, on which browser software is operating, unlike the method 100 previously described above, the method 200 is preferably used for browsers incapable of supporting, operating, or running rich media, such as a SCRIPT or IFRAME, or when a server only solution is desired that does not require a user's computer to operate or execute rich media files.

During the method 200, a user's browser, for example the browser operating on the computer 24, sends or initiates a fetch web page request during step 202 to a web site server, such as the server 46, that requests that the web site server send or serve a web page to the user's browser. Such a fetch web page command or request generated by the user's browser during the step 202 might take the form of, for example, http://www.excite.com/WebPage1.html. The step 202 in the method 200 is generally similar to the step 102 in the method 100 previously described above.

The web site server to which the fetch web page request is sent during the step 202 will then serve or send the desired web page to the user's browser during step 204. The web page sent or served to the user's browser during step 204 will include a link or other reference to an image or banner to be fetched or requested by the user's browser during step 206. The image may or may not be located on the same server or device as the original web page fetched or requested by the user's browser during the step 202. For example, the web page fetched or requested by the user's browser during the step 202 may be located on the server 46 while the image fetched by the user's browser during the step 206 may be located on the server 46, the ad selection server 32, the media server 38, or some other device connected to the computer network 22. For purposes of further explanation, but not limitation, of the method 200, the image will be assumed to be stored on or located at the ad selection server 32.

Upon receipt by the user's browser of the desired web page served during the step 204, the user's browser will send a fetch image request during the step 206. Such a fetch image command or request generated by the user's browser during the step 206 might take the form of, for example:

http://ad.preferences.com/image;spacedesc=Campaign1_Site1_{—}468×60_Package1_Location1.

Upon receipt of the image request generated by the user's browser during the step 206, the ad selection server 32 will serve or send a redirect signal or command to the user's browser during step 208. The redirect signal or command generated and sent during the step 208 may be, for example, a Status HTTP 302 Redirect that directs the user's browser to generate and send another command to fetch the image, as will be described in more detail below. A Status HTTP 302 Redirect command may take the form of, for example:

HTTP/1.0 302 Moved Temporarily

totalcnt=516

duration 0.20

Connection: close

Date: Tue, Oct 27, 1998 15:50:54 GMT

Location: http://204.152.166.208/new.gif

Server: Apache/1.2.1

Content-Type: text/html

Client-Date: Tue, Oct 27, 1998 15:50:53 GMT

Set-Cookie: PreferenceslD=HXHV-u4uq10TtqNfT4Dw6q; expires=Mon, Jun 18, 2007 04:20:21

GMT; path=/; domain=.preferences.com

Title: 302 Moved Temporarily

<HTML><HEAD>

<TITLE>302 Moved Temporarily</TITLE>

</HEAD><BODY>

<H1>Moved Temporarily</H1>

The document has moved <A HREF=“http://204.152.166.208/new.gif”>here</A>.<P>

</BODY></HTML>

Essentially, when the ad selection server 32 or other device sends a redirect command, the ad selection server 32 or other device is telling or providing the recipient of the redirect command with another location of the desired image, banner, file, etc. Preferably, the redirect command sent during the step 208 directs the user's browser to fetch or request another image from the same server (in this example, the ad selection server 32) that generated the redirect signal, as will be discussed in more detail below.

During step 210, the ad selection server 32 also starts a clock or timer, or notes the current time, to measure the transfer time between the ad selection server 32 and the user's computer. The step 210 can be performed prior to or after the step 208 or simultaneously with the step 208.

After the user's browser receives the redirect signal or command generated and sent during the step 208, the user's browser fetches or requests another image during the step 212. As previously described above, the fetch image request generated by the user's browser during the step 212 is preferably directed to the same server or computer as was the fetch image request generated by the user's browser during the step 206 (in this example, the ad selection server 32). If so, the same server that received the previous fetch image request generated by the user's browser during the step 206 will receive the second fetch page request generated by the user's browser during the step 212. In this example, the ad selection server 32 would receive both fetch image requests generated by the user's browser.

Upon receipt during step 214 of the second fetch image request sent by the user's browser during the step 212, the ad selection server 32 preferably will stop the clock or timer, or note the current time, during step 216 that was previously started or initiated by the ad selection server 32 during the step 210. From the clock or timer information, or the elapsed time information generated by noting the current time during steps 210 and 216, the elapsed transfer time between the ad selection server 32 and the user's computer can be determined by the ad selection server 32 or some other device and used in computing the user's bandwidth. The bandwidth determination for the user can be used to select or configure email, web pages, executable software, banners or other content for delivery or serving to the user's browser, as described above in relation to the method 100.

Also after receiving the image request during the step 214, the ad selection server 32 may optionally serve or send content to the user's computer or browser for display to the user during step 218. The steps 216, 218 may be performed in any order or simultaneously. The ad selection server 32 may also optionally send the information regarding transfer time and user bandwidth to other servers or computers, such as the proton servers 40, 42, media server 38, or log server 48, during step 220, a log file, or a profile repository. In addition, the ad selection server 32 may store the transfer time and/or bandwidth information on the ad selection server 32 itself and/or cause the transfer time and/or bandwidth information to be stored in a cookie on the user's computer during step 220. The steps 218, 220 may also be performed simultaneously or in reverse order and either or both of steps 218, 220 may be eliminated in its entirety without affecting the computation of the transfer time and user bandwidth.

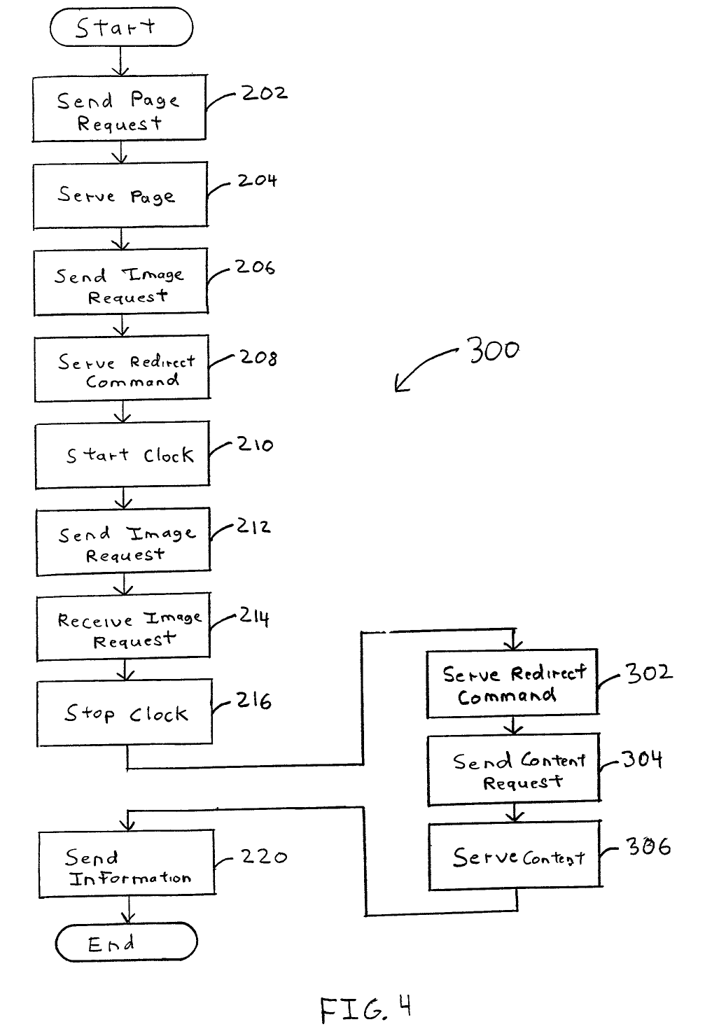

A third embodiment 300 of a method designed in accordance with the principles of the present invention is illustrated in FIG. 4. The method 300 includes many of the same steps previously described above for the method 200. In fact, steps 202, 204, 206, 208, 210, 212, 214, 216, and 220 are the same for the method 300 and the method 200. In contrast to the method 200, however, the method 300 includes optional steps 302, 304, and 306 between steps 216 and 220, and does not include the step 218. The steps 302, 304, and 306 of the method 300 will now be described in more detail.

After the ad selection server 32 stops the clock or time during step 216, the ad selection server 32 sends a second redirect signal or command, which may be a Status HTTP 302 Redirect, during the step 302. Unlike the redirect signal or command generated by the ad selection server 32 during the step 208, however, which caused the user's browser to attempt a second fetch of an image from the ad selection server 32, the redirect signal or command generated by the ad selection server 32 during the step 302 will preferably direct the user's browser to content located on a different server or device connected to the computer network 22, such as the media server 38. Such a redirect command may take the form as provided in the example above.

Before the ad selection server 32 sends the redirect signal during the step 302, the ad selection server 32 may select or configure the content that is to be sent or served eventually to the user's browser. The content selected by the ad selection server 32 to be served to the user's browser may be selected, at least in part, by the transfer time and/or user bandwidth computed earlier.

After the user's browser receives the redirect command sent by the ad selection server during the step 302, the user's browser will fetch or request the selected content during step 304 from the media server 38. The media server 38 will then serve or send the requested or fetched content during step 306. Such a fetch content request may take the form of, for example: http://ad.preferences.com/image; spacedesc=Campaign1_Site1_{—}468×60_Package1_Location1.

The steps 216, 220, 302 may occur simultaneously or in a different order. In addition, the step 220 may occur before one or all of the steps 302, 304, 306 or simultaneously with any of the steps 302, 304, 306. In addition, any or all of the steps 302, 304, 306, 220 may be eliminated from the method 200 without affecting the bandwidth or transfer time determinations.

A fourth embodiment 400 of a method designed in accordance with the principles of the present invention includes the use of a sniffer, such as the sniffer server 44. As previously discussed above, a sniffer is generally a software utility that resides and operates on a server, computer, host, etc. The sniffer software captures data and packet traffic and allows analysis of such data and packet traffic. In the example network apparatus provided in FIG. 1, the sniffer server 44 is connected to the computer network 22 and also to the ad selection server 34 and the media server 36. Traffic and data communication between the ad selection server 34, the media server 36, and the computer network 22 all pass through the sniffer server 44. Therefore, the sniffer software resident and operating on the sniffer server 44 can examine the traffic and data communication between the ad selection server 34, media server 36, and the computer network 22. In general, the method 400 works similarly to either of the methods 200 and 300 previously described above except that steps 210 and 216 are not needed. Since the sniffer server 44 can monitor traffic flowing from the ad selection server 34 and the media server 36 to the computer network 22, and vice versa, the sniffer server can monitor when image requests are generated that are received by the ad selection server 34 and the media server 36, the sniffer can monitor the time and date that each image request passes through the sniffer server 44 and the time each redirect command or image passes through the sniffer server. From such monitored measurements, the transfer time and/or bandwidth between the ad selection server 34 and a user's computer and the transfer time and/or bandwidth between the media server 36 and the user's computer can be determined, stored, and sent to other devices connected to the computer network 22 such as the proton servers 40, 42 or the log server 48. The sniffer server might also send information to the other devices connected to the computer network 22, such as the size or type of file used to determine the transfer time and/or user bandwidth, any cookie IP address, or other information that might be associated with the user or the user's computer or browser.

One advantage of the method 400 is that it is an entirely passive approach. That is, the method 400 simply watches packets or traffic as they flow back and forth on the computer network 22. Therefore, from a user's perspective, there are no performance penalties created. Another advantage of the method 400 is that the method 400 does not require any special software to be resident or installed on a user's computer.

A disadvantage of the method 400 is that the sniffer server needs to monitor most, if not all, traffic that passes through it to extract the information needed to compute transfer times and bandwidth. Therefore, the method 400 is labor intensive and may prevent the sniffer server from being used simultaneously for other purposes. Another disadvantage of the method 400 is that errors in transfer time and/or bandwidth calculations can be introduced, particularly when a user's computer, such as the computer 26, is connected to the computer network 22 via a caching proxy server, such as the proxy server 30. The problem is created when the user's computer has a low bandwidth or slow connection to the caching proxy server while the proxy server has a high bandwidth or fast connection to an ad selection server and/or media server. From the sniffer server's point of view, the bandwidth or transfer time estimate will reflect the throughput or transfer time between the sniffer server and the proxy server and not the throughput or transfer time between the sniffer server and the user's computer. An incorrect calculation of transfer time or bandwidth may result in the transfer of a rich media advertisement over a low bandwidth connection to a user's computer, thereby potentially creating an unsatisfied or disgruntled user.

As previously discussed above, the methods 100, 200, 300, 400 are usable in an ad selection and serving application. In addition, each of the methods 100, 200, 300, 400 are usable for dynamically selecting or configuring content, executable software, web pages, or electronic mail (email) to be served or sent to a user or a user's browser. A use of any of the methods 100, 200, 300, 400 in an ad or web page selection or configuration implementation might allow different levels of content to be included or excluded based on the user's bandwidth. The content selected for delivery to the user could include or exclude, for example, more or less formatted text, more or fewer images (each using more or less animation), audio, video, Java Applets, configuration information for Java Applets, etc. based on the user bandwidth or the transfer time to the user. Configuration of executable software would allow, for example, some Internet-enable software to configure itself or other software in the amount of type of software features or in the way the software executes on a computer or other device.

A specific implementation of the method 100 in such an ad selection and serving application using the Internet might proceed as follows: First, a user's browser makes a request to a web site for a web page to be served over the Internet to the user's browser. This corresponds to the step 102 in the method 100. Next, a web server at the web site serves the requested web page to the user's browser via the Internet. This corresponds to the step 104 in the method 100.

The content served by the web site's web server may include references to additional content, which may also be served by the web site's web server, or which may be served by other web servers. This scenario assumes that the web page includes a reference to an ad selection server is included in the content.

The user's browser then renders or displays content received from the web site's web server. Reference in the content to ad selection server causes a rich media request to be made by the user's browser to the ad selection server. This corresponds to the step 106 in the method 100.

The ad selection server receives the rich media request from the user's browser. As the HTTP specification states, when a request made by a browser to a server, “cookies” previously set by that server (or servers in that server's domain) are sent in the “header” of that request. If the ad selection server took measurements (bandwidth, CPU, etc.) in the past in the past for the user, that data is now available to this process and may affect the behavior of the ad selection by the ad selection server. Speed-related information may not be available in the cookie sent with the request, but the user's unique identifier may be.

If measurements for the user were previously taken and stored in, for example, a proton server, the ad selection server may refer to the proton server for speed or bandwidth information associated with the user. Whether or not the proton server has speed data about the user and what the data values are can determine whether further measurements are taken and what ad is eventually served by the ad selection server to the user's browser.

If no bandwidth measurement data for the user exists, the ad selection server may optionally invoke a determination of bandwidth between the user's browser and the ad selection server by serving rich media to the user's browser. The rich media served to the user's browser will include a logic file to be executed by the user's browser upon receipt of the logic file. This corresponds to step 108 in the method 100.

Upon receipt of the rich media by the user's browser, the user's browser will execute the logic file. This corresponds to step 110 in the method 100. The logic file executed by the user's browser can instruct the browser to do one or more of the following:

a. Optionally, look for a cookie stored on the user's computer containing bandwidth measurements previously taken. If a cookie exists, the bandwidth measurements and other information stored in the cookie could affect subsequent behavior of the user's browser and the logic file. For example, if many measurements have determined the user to have a slow connection, the browser may send such information to the ad selection server such that the ad selection server selects a small ad to be served to the user's browser.

b. If no cookie exists on the user's computer with the bandwidth measurement information, the logic file may instruct the user's browser to take a bandwidth measurement. In order to do so, execution of the logic file directs the user's browser makes note of the current time (T₀), send an image request (during the step 112 of the method 100) to the ad selection server, receive an image from the ad selection server (during the step 114 of the method 100) in response to the image request, note the current time again (T₁), and determine the total transfer time (T₁-T₀). Each of these procedures can be included in step 110 of the method 100. The results of the total transfer time measurement can be transmitted to the ad selection server or some other device or stored in a cookie on the user's computer as part of the step 110 or the step 116 in the method 100. The logic file may be configured so that the transmission of the transfer time information occurs as part of a request to the ad selection server or other device, and could have the form of the following:

http://ad.preferences.com/data.ng;spacedesc=Campaign1_Site1_{—}468×60_Package1_ Location1&ML_MTHD=JS_v1&ML_FSZ=2112&ML_LDTM=20&ML_CSPD=5 150

c. Optionally, the logic file could cause the user's browser or computer perform a CPU speed measurement of the user's computer (basically, performing some function such as generation of a random number some number of times and noting how long that took). Each of these procedures can be included in step 110 of the method 100. The results of the CPU speed measurement can be transmitted to the ad selection server or some other device or stored in a cookie on the user's computer as part of the step 110 or the step 116 in the method 100. The logic file may be configured so that the transmission of the CPU speed measurement occurs as part of a request to the ad selection server or other device.

After the bandwidth or travel time measurement is made, the user's browser may subsequently request content be served to the user's browser. The ad server selects and serves the appropriate content to the user based on the user's bandwidth. For example, if the user's bandwidth is too slow, the ad selection server, upon receipt of a request by the user's browser, may send content having a small size, a black and white image for example, to the user's browser.

If information regarding the user's bandwidth and/or CPU configuration are stored on devices connected to a computer network, such a proton server, access to the proton server, and the user information stored thereon, may be offered to third parties, such as web site owners. Assuming a third party's system has such access to the user information, their web server may receive a request for a web page that is to be customized based on each user's effective bandwidth. Their system would make a request to the proton server for speed data about a particular user, providing the user's unique identifier. If data for that user is available, it is returned to the system. Using that information, the third party system may dynamically construct the web page specific to that user's capabilities. For example, if the user is determined to have a slow Internet connection, the web page may be short and contain few image references. Rich media may be available to the user, but not included on the web page. In contrast, if a user has a fast connection, the web page built for them may contain many images, even audio and video playing as they load the web page. Data on users in the proton server would be available within seconds or minutes from when the measurements are taken.

User data may also be stored on or added to a log server or profile repository associating users with effective bandwidth. Third party systems could have access to data about users' connections and systems similar to how described for the proton server. The difference is that the proton server's data is provided in close to real-time, where a profile repository's data is generally available only after post-processing the log files.

The foregoing description is considered as illustrative only of the principles of the invention. Furthermore, since numerous modifications and changes will readily occur to those skilled in the art, it is not desired to limit the invention to the exact construction and process shown and described above. Accordingly, all suitable modifications and equivalents may be resorted to falling within the scope of the invention as defined by the claims that follow. For example, the methods 100, 200, 300, 400 described above may be used to aide in dynamically creating or generating web pages or content before such web pages or content are delivered or served to a user (i.e., in determining the sizes and types of images, files, etc. included in the web page), in deciding whether or not serve rich media to a client/user, or to make data regarding the user's system configuration, bandwidth, etc. available via proton servers or on the user's computers for other uses. In addition, information stored and/or created along with transfer time and/or user bandwidth information might include the time/date of the transfer time computation, user information, information regarding the configuration or capabilities of the user's computer, the file size(s) of file(s) downloaded or served to the user, and/or an identification, cookie, or Internet Protocol (IP) address associated with the user. The term “content” as used herein, should also be construed broadly, and is not intended to have any type of limited definition. Content may include or comprise banners, text, Java Applets, JavaScript, VBSCRIPT, and other SCRIPT, IFRAME references, video, audio, or other types of rich media or information. In addition, the definitions of the terms “travel time” and “transfer time” should not be limited in any way and different definitions may be used without varying from the scope of the present invention. For example, the terms “travel time” and “transfer time” may be defined as the total elapsed time between the time when a server begins serving an ad or image and the time when the device requesting the ad or image receives the complete ad or image. Alternatively, these terms may be defined as the time between when a device first requests an ad or image and the time when the ad or image is first being received by the device or the time when the ad or image has been fully received by the device. The term “executable software,” as used herein, should not be limited and includes and encompasses, but is not limited to, computer programs, or applications, computer or software code, lists or sequences of computer or browser implementable or executable instructions, commands, program steps, codes, etc., SCRIPTS, script files, Java Applets and program listings, regardless of format or form (including electronic and print), and any and all other forms of software or programming that can be operated with a computer or browser, regardless of form or format.

The following JavaScript is for use with the method 100 previously described above and is particularly directed to browsers that can render/execute an “IFRAME” tag.

```
<html>
<head><script>
<!--
var tt1,tt2 = 0,bytesPerMilli;
var loopsPerMilli = 1;
var lim = 1; // dynamic package name & bandwidth limit
var imageSize = 4288;//number of bytes for this image
var loadCount=0;
var N = 1000;//initial value of number of loops to perform
var K = 25;//number of milliseconds to perform N number of loops for
var elapsedTime = 0;
var isOkBrowser = navigator.appVersion && navigator.appVersion.substring(0,1) > 3;
function setCookie (BPM,LPM,tMeasure) {
  var volatility = 86400000 * 7;
  var cookieLife = new Date(tMeasure + volatility);
  var cookieString = cookieLife.toGMTString();
  var newCookie = “Bpm=” + BPM + “-” + LPM + “-” + tMeasure + “;expires=” + cookieString +
”;
path=/”;
  document.cookie = newCookie;
alert(“Setting cookie :” + newCookie);
}
function tstart() {
if (loadCount == 0) {
    loopsPerMilli = checkCpu();
    tt1 = (new Date()).getTime();
  }
}
function tend() {
  if (loadCount++ == 0) {
    tt2 = (new Date()).getTime();
    elapsedTime = tt2 − tt1;
    if (elapsedTime < 1) elapsedTime = 1;//so that bytesPerMilli does not become infinity
    bytesPerMilli = imageSize / elapsedTime;
    setCookie(bytesPerMilli,loopsPerMilli,tt1);
    logSpeed();
  }
}
function showRich() {
window.location.href=“http://unclec.matchlogic.com:2022/iframe.ng;spacedesc=@@ML_ADNET
@@_@@ML_SITE@@_@@WIDTH@@x@@HEIGHT@@_speed_any&ML_MTHD=JS_vl&
ML_FSZ=” + imageSize + “&ML_LDTM=” + elapsedTime + “&ML_CSPD=” + (loopsPerMilli *
1000);
}
function logSpeed() {
  if (isOkBrowser) {
  im2 = new Image();
  im2.src =
“http://unclec.matchlogic.com:2022/data.ng;spacedesc=@@ML_ADNET@@_@@ML_SITE@@
_@@WIDTH@@x@@HEIGHT@@_runofsite_any&ML_MTHD=JS_vl&ML_FSZ=” +
imageSize + “&ML_LDTM=” + elapsedTime + “&ML_CSPD=” + (loopsPerMilli * 1000);
  }
}
function checkCpu() {
  var eTime =0;
  while (eTime < K) {
    N *= 2;
    eTime = getElapsedTime();
  }
  return (N / eTime);
}
function getElapsedTime() {
  var t3,t4;
  t3 = (new Date()).getTime();
  for (var i =0; i < N; ++i) {}
  t4 = (new Date()).getTime();
  return (t4 − t3);
}
function isCookieSet() {
    var currentCookie = document.cookie;
    var pos = currentCookie.indexOf(“Bpm=”);
    if(pos != −1) {
      var start = pos + 4;
      var end = currentCookie.indexOf(“−”,start);
      if (end == −1) end = currentCookie.length;
      bytesPerMilli = currentCookie.substring(start,end);
      loadCount=1;
      start = end + 1;
      end = currentCookie.indexOf(“−”,start);
      if (end == −1) end = currentCookie.length;
      loopsPerMilli= currentCookie.substring(start,end);
      return true;
  } else {
  return false;
  }
}
//-->
</script>
</head>
<body onLoad=“tend();”>
<script>
<!--
if (isCookieSet()) {
// alert(“Cookie is Set! No need to remeasure!”);
  elapsedTime = imageSize / bytesPerMilli;
//alert(“Bpm=” + bytesPerMilli + “lpm=” + loopsPerMilli + “etime=” + elapsedTime + “imsize=”
+ imageSize);
  if(bytesPerMilli > lim) {
    showRich();
  } else {
    document.write(‘<A
HREF=“http://unclec.matchlogic.com:2022/click.ng;spacedesc=@@ML_ADNET@@_@@ML_S
ITE@@_@@WIDTH@@x@@HEIGHT@@_image_any&random=@@ML_TIME@@&group
=MediaType&event=html&click=@@ML_REDIRECT@@http%3A%2F%2Fwww.covergirlcom
” target=_blank>’);
    document.write(‘<IMG
SRC=“http://unclec.matchlogic.com:2022/image.ng;spacedesc=@@ML_ADNET@@_@@ML_S
ITE@@_@@WIDTH@@x@@HEIGHT@@_image_any&random=@@ML_TIME@@&ML_
MTHD=JS_vl&ML_FSZ=‘ + imageSize + ‘&ML_LDTM=’ + elapsedTime + &ML_CSPD=‘ +
(loopsPerMilli * 1000) + ‘“></A>’);
  }
} else {
  tstart();
  document.write(‘<A
HREF=“http://unelec.matchlogic.com:2022/click.ng;spacedesc=@@ML_ADNET@@_@@ML_S
ITE@@_@@WIDTH@@x@@HEIGHT@@_image_any&random=@@ML_TIME@@&group
=MediaType&event=html&click=@@ML_REDIRECT@@http%3A%2F%2Fwww.covergirl.com
” target=_blank>’);
  document.write(‘<IMG
SRC=“http://unclec.matchlogic.com:2022/image.ng;spacedesc=@@ML_ADNET@@_@@ML_S
ITE@@_@@WIDTH@@x@@HEIGHT@@_image_any&random=@@ML_TIME@@”
width=@@WIDTH@@height=@@HEIGHT@@></A>‘);
}
// -->
</script>
<noscript>
<A
HREF=“http://unclec.matchlogic.com:2022/click.ng;spacedesc=@@ML_ADNET@@ML_SITE
@@WIDTH@@x@@_image_any&random=@@ML_TIME@@&group=MediaTy
pe&event=html&click=@@ML_REDIRECT@@http%3A%2F%2Fwww.covergirl.com”
target=_blank>
<IMG
SRC=“http://unclec.matchlogic.com:2022/image.ng;spacedesc=@@ML_ADNET@@@_@@ML_S
ITE@@_@@WIDTH@@x@@HEIGHT@@_image_any&random=@@ML_TIME@@“></A>
</noscript>
</body>
</html>
```

The following JavaScript is for use with the method 100 previously described above and is particularly directed to browsers that CANNOT render/execute the “IFRAME” tag, but can interpret/execute JavaScript.

```
var tt1,tt2 = 0,bytesPerMilli = 0,loopsPerMilli;
var lim = 1.4; // dynamic package name & bandwidth limit
var imageSize = 4288;//number of bytes for this image
var loadCount=0;
var N = 1000;//initial value of number of loops to perform
var K = 25;//number of milliseconds to perform N number of loops for
var delay = 500;//delay in milliseconds needed
//var isOkBrowser = navigator.appVersion && (navigator.appVersion.substring(0,1) > 3) &&
(navigator.appVersion.indexOf(“4.01”) == −1);
var isOkBrowser = navigator.appVersion && (navigator.appVersion.substring(0,1) > 3);
function setCookie (BPM,LPM,tMeasure) {
  var volatility = 86400000 * 7;
  var cookieLife = new Date(tMeasure + volatility);
  var cookieString = cookieLife.toGMTString();
  var newCookie = “Bpm=” + BPM + “−” + LPM + “−”+ tMeasure + “;expires=” + cookieString +
”;
path=/”;
  document.cookie = newCookie;
alert(“Setting cookie:” + newCookie);
}
function tstart() {
    if ( loadCount == 0) {
        loopsPerMilli = checkCpu();
        tt1 = (new Date()).getTime();
    }
}
function tend() {
    if ( loadCount++ == 0) {
        tt2 = (new Date()).getTime();
      elapsedTime = tt2 − tt1 − delay;
      if (elapsedTime < 1) elapsedTime = 1;//ensure elapsed is not too small
        bytesPerMilli = imageSize / elapsedTime;
      setCookie(bytesPerMilli,loopsPerMilli,tt1);
        logSpeed();
    }
}
function logSpeed() {
    iml.src =
“http://unclec.matchlogic.com:2022/data.ng;spacedesc=@@ML_ADNET@@_@@ML_SITE@@
_@@WIDTH@@x@@HEIGHT@@_runofsite_any&ML_MTHD=JS_vl&ML_FSZ” +
imageSize + “&ML_LDTM=” + elapsedTime + “&ML_CSPD=” + (loopsPerMilli * 1000);
}
function checkCpu() {
    var eTime = 0;
    while (eTime < K) {
      N *= 2;
      eTime = getElapsedTime();
    }
  return (N / eTime);
}
function getElapsedTime() {
    var t3,t4;
    t3 = (new Date()).getTime();
    for (var i = 0; i < N; ++i) { }
    t4 = (new Date()).getTime();
    return (t4 − t3);
}
function isCookieSet() {
    var currentCookie = document.cookie;
    var pos = currentCookie.indexOf(“Bpm=”);
    if(pos != −1) {
      var start = pos + 4;
      var end = currentCookie.indexOf(“−”,start);
      if (end == −1) end = currentCookie.length;
      bytesPerMilli = currentCookie.substring(start,end);
    start = end + 1;
    end = currentCookie.indexOf(“−”,start);
    if (end == −1) end = currentCookie.length;
    loopsPerMilli= currentCookie.substring(start,end);
      return true;
    } else {
      return false;
    }
}
function showDefBanner() {
    document.write(ka
href=“http://unclec.matchlogic.com:2022/click.ng;spacedesc=@@ML_ADNET@@_@@ML_SIT
E@@_@@WIDTH@@x@@HEIGHT@@_image_any&random=@@ML_TIME@@&group=
MediaType&event=html&click=@@ML_REDIRECT@@http%3A%2F%2Fwww.covergirl.com”
target=_blank>‘);
    document.write(‘<IMG
SRC=“http://unclec.matchlogic.com:2022/image.ng;spacedesc=@@ML_ADNET@@_@@ML_S
ITE@@_@@WIDTH@@x@@HEIGHT@@_image_any&random=@@ML_TIME@@“></a>‘)
;
}
if (isOkBrowser) {
    if (isCookieSet()) {
      if(bytesPerMilli > lim) {
        elapsedTime = imageSize / bytesPerMilli;
        document.write(‘<scr’);
        document.write(‘ipt
src=http://unclec.matchlogic.com:2022/jscript.ng;spacedesc=@@ML_ADNET@@_@@ML_SIT
E@@_@@WIDTH@@x@@HEIGHT@@_speed_any&ML_MTHD=JS_vl&ML_FSZ=‘ +
imageSize + ‘&ML_LDTM=‘ + elapsedTime + ‘&ML_CSPD=1></scr‘);
        document.write(‘ipt>’);
      } else {
        showDefBanner();
      }
    } else {
      tstart();//check the initial time
      im1 = new Image();
      document.write(‘<a
href=“http://unclec.matchlogic.com:2022/click.ng;spacedesc=@@ML_ADNET@@_@@ML_SIT
E@@_@@WIDTH@@x@@HEIGHT@@_image_any&random=@@ML_TIME@@&group=
MediaType&event=html&click=@@ML_REDIRECT@@http%3A%2F%2Fwww.covergirl.com”
target=_blank>‘);
      document.write(‘<IMG
SRC=“http://unclec.matchlogic.com:2022/image.ng;spacedesc=@@ML_ADNET@@_@@ML_S
ITE@@_@WIDTH@@x@@HEIGHT@@_image_any&random=@@ML_TIME@@”
onLoad=setTimeout(“tend()”,delay)></a>‘);
    }
} else {
    showDefBanner();
}
```

In the examples provided above, many references are made to Mathlogic servers and

systems which are owned or controlled by Matchiogic, Inc., of Westminster, Colo., U.S.A. For purposes of further explanation of the previous two examples, the following description provides information and techniques related to the Matchlogic servers and systems as used in the previous two examples.

The string “http://unclec.matchlogic.com:2022” is for demonstration purposes only and, in general use, may constructed more like the following: “http://ad.preferences.com”.

For HTTP requests that contain the following strings:

“http://unclec.matchlogic.com:2022/iframe.ng;spacedesc=” or

“http://unclec.matchlogic.com:2022/jscript.ng;spacedesc=”, these requests cause the MatchLogic ad selection servers and related systems to select rich media content (either a script file which could be JavaScript and would execute on the browser, or a “.html” file which is HTML formatted web page content and could contain script statements, for example, written in JavaScript). Another purpose for using this technique is to measure that the rich media was served to the requesting system. If selection of content is to be done by Matchlogic ad selection servers, then this technique may be used. If not, the HTTP request may be constructed as in the following example:

“http://media.preferences.com/campaign1/RichMediaAd1.html” or

“http://media.preferences.com/campaign1/RichMediaAd1.js”.

Usage of HTTP requests that contain the following string: “http://unclec.matchlogic.com:2022/image.ng;spacedesc=”, cause the MatchLogic ad selection servers and related systems to select an image file (usually, but not limited to, GIF, JPG or other standardized graphics file format). Another purpose for using this technique is to measure that the image was served. If selection of content is to be done by MatchLogic ad selection servers, then this technique may be used. If not, the HTTP request may be constructed as in the following example: “http://media.preferences.com/campaign1/SimpleMediaAd1.gif”.

Usage of HTML references that contain the following string:

“<a href=“http://unclec.matchlogic.com:2022/click.ng;spacedesc=”, cause the MatchLogic ad selection servers and related systems to record that a user performed some sort of interaction with the media rendered by the browser. For example, the user may click on a banner advertisement image or click on a button with their mouse or other user interface device. If selection of content is not to be done by Matchlogic ad selection servers, the reference may be constructed as in the following example: <a href=“http://www.xyz.com/HomePage.html”.

Usage of HTTP requests that contain the following string: “http://unclec.matchlogic.com:2022/image.ng;spacedesc=”, cause data to be sent to MatchLogic servers (such as ad selection servers and/or media servers) so that they can propagate that information to other servers of various types (such as the proton servers) and so they can add that data to activity log files, which are processed to extract data for further use.

The embodiments of the invention in which an exclusive property or privilege is claimed are defined as follows:

1. A method for determining transfer time between a client and a first server connected to a computer network, comprising:
serving a piece of information from the first server to the client, wherein said piece of information contains executable software;
executing said executable software;
sending an image request from the client to the first server requesting a location address for an image to be served to the client; and
serving said image to said client as a result of said image request signal.

2. The method of claim 1, wherein said first piece of information is a web page.

3. The method of claim 1, wherein said executable software includes rich media.

4. The method of claim 3, wherein said rich media includes SCRIPT.

5. The method of claim 1, wherein said executing of said executable software causes the client to send said image request signal.

6. The method of claim 1, wherein said executing of said executable software causes the client to start a timer when the client sends said image request.

7. The method of claim 6, wherein said executing of said executable software causes the client to stop said timer when said image is received by the client.

8. The method of claim 1 wherein said executing of said executable software causes the client to monitor a time period between said sending of said image request and receipt by the client of the image requested.

9. The method of claim 8, wherein said executing of said executable software causes the client to send information representative of said time period to at least one other device connected to the computer network.

10. The method of claim 8, including computing client bandwidth.

11. The method of claim 10, wherein said executing of said executable software causes the client to send information representative of said client bandwidth to at least one other device connected to the computer network.

12. The method of claim 10, wherein said second server is distinct from said first server.

13. The method of claim 10, wherein said second server is said first server.

14. The method of claim 1, wherein said executing of said executable software causes the client to perform an operation that can be monitored by the client.

15. The method of claim 14, wherein said operation is internal to the client.

16. The method of claim 1, wherein said executing of said executable software creates a signal indicative of the client's processing capabilities.

17. A method for distributing information over a computer network to a device, comprising:
sending a page request signal from the device to a first server requesting that a page be served to the device;
serving said requested page to said device, wherein said page includes location information for a portion of executable software located on a second server;
sending a request signal from said device to said second server requesting that said executable software be served to said device;
serving said requested executable software to said device;
executing said executable software;
sending an image request signal from said device for an image; and
serving said requested image to said device.

18. The method of claim 17, wherein said first server is said second server.

19. The method of claim 17, wherein said first server is said third server.

20. The method of claim 17, wherein said second server is said third server.

21. The method of claim 17, wherein said executable software includes rich media.

22. The method of claim 21, wherein said rich media includes SCRIPT.

23. The method of claim 21, wherein said rich media includes VBSCRIPT.

24. The method of claim 17, wherein said executing of said executable software initiates said sending of said image request signal.

25. The method of claim 17, wherein said executing of said executable software causes the device to start a timer when the device computer sends said image request.

26. The method of claim 25, wherein said executing of said executable software causes the device to stop said timer when said image is received by the device.

27. The method of claim 17 wherein said executing of said executable software causes the device to monitor a time period between said sending of said image request and receipt by the device of the image requested.

28. The method of claim 27, wherein said executing of said executable software causes the device to send information representative of said time period to at least one other device connected to the computer network.

29. The method of claim 27, including computing the device's bandwidth.

30. The method of claim 29, wherein said executing of said executable software causes the device to send information representative of said bandwidth to at least one other device connected to the computer network.

31. The method of claim 17, wherein said executing of said executable software creates a signal indicative of the device's processing capabilities.

32. A method for delivering information over a computer network to a computer, comprising:
serving a piece of information from a first server to the computer, wherein said piece of information includes location information for an image;
sending a first image request from the computer;
serving a redirect signal to the computer in response to said first image request;
sending a second image request from the computer; and
serving said second image to said computer.

33. The method of claim 32, wherein said second image is located on a second server distinct from said first server.

34. The method of claim 33, wherein said first image is located on said first server.

35. The method of claim 32, wherein said first image is located on said second server.

36. The method of claim 32, wherein said redirect signal includes a Status HTTP 302 Redirect.

37. The method of claim 32, wherein said piece of information includes a web page.

38. The method of claim 33, including said second server initiating a timer in conjunction with said serving of said redirect signal.

39. The method of claim 38, wherein said second server receives said second image request.

40. The method of claim 39, including said second server stopping said timer when said second server receives said second image request.

41. The method of claim 40, including said second server computing transfer time between said second server and said computer.

42. The method of claim 40, including said second server computing said computer's bandwidth.

43. The method of claim 40, including said second server sending information representative of said timer to some other device connected to the computer network.

44. The method of claim 32, including said second server receiving said second image request and monitoring transfer time between said second server and the computer.

45. The method of claim 32, including computing bandwidth between said second server and the computer.

46. The method of claim 45, including sending information relating to said bandwidth computation to another device connected to said computer network.

47. The method of claim 45, including storing information relating to said bandwidth computation on the computer.

48. The method of claim 47, including storing information related to said bandwidth computation in a cookie stored on said computer.

49. A method for delivering information over a computer network to a computer, comprising:
serving a piece of information from a first server to the computer, wherein said piece of information includes location information for an image;
sending a first image request from the computer;
serving a first redirect signal to the computer in response to said first image request;
sending a second image request from the computer;
serving a second redirect signal to the computer in response to said second image request;
sending a content request from the computer; and
serving said requested content to said computer.

50. The method of claim 49, wherein said second image is located on a second server distinct from said first server.

51. The method of claim 49, wherein said first image is located on said first server.

52. The method of claim 49, wherein said first image is located on said second server.

53. The method of claim 49, wherein said requested content is located on a second server distinct from said first server.

54. The method of claim 50, wherein said requested content is located on a third server distinct from said first and second servers.

55. The method of claim 49, wherein said requested content is located on said first server.

56. The method of claim 49, wherein said first redirect signal includes a Status HTTP 302 Redirect.

57. The method of claim 49, wherein said second redirect signal includes a Status HTTP 302 Redirect.

58. The method of claim 49, wherein a second server serves said first redirect signal.

59. The method of claim 58, including said second server initiating a timer in conjunction with said serving of said first redirect signal.

60. The method of claim 59, wherein said second server receives said second image request.

61. The method of claim 60, including said second server stopping said timer when said second server receives said second image request.

62. The method of claim 61, including said second server computing transfer time between said second server and said computer.

63. The method of claim 61, including said first server computing said computer's bandwidth.

64. The method of claim 61, including said second server sending information representative of said timer to some other device connected to the computer network.

65. The method of claim 49, including a second server receiving said second image request and monitoring transfer time between said second server and the computer.

66. The method of claim 49, including a second server receiving said second image request and computing the computer's bandwidth.

67. The method of claim 49, including computing the computer's bandwidth.

68. The method of claim 67, including sending information relating to said bandwidth computation to another device connected to said computer network.

69. The method of claim 68, including storing information relating to said bandwidth computation on the computer.

70. The method of claim 49, including computing the computer's bandwidth.

71. The method of claim 70, including sending information relating to said bandwidth computation to another device connected to said computer network.

72. The method of claim 70, including storing information relating to said bandwidth computation on the computer.

73. The method of claim 72, including using said information during selection of content to be served to the computer.

74. The method of claim 11, including using said information during selection of content to be served to the client.

75. The method of claim 16, wherein said executing of said executable software causes the client to send information representative of the client's processing speed to at least one other device connected to the computer network.

76. The method of claim 75, including using said information during selection of content to be served to the client.

77. The method of claim 11, including using said information during selection of executable software to be served to the client.

78. The method of claim 30, including using said information during selection of content to be served to the device.

79. The method of claim 30, including using said information during selection of executable software to be served to the device.

80. The method of claim 46, including using said information during selection of content to be served to the computer.

81. The method of claim 46, including using said information during selection of executable software to be served to the computer.

82. The method of claim 47, including using said information during selection of content to be served to the computer.

83. The method of claim 47, including using said information during selection of executable software to be served to the computer.

84. A method for serving information over a computer network to a client, comprising:
serving a web page from a first server to the client, wherein said web page includes a reference to an image;
sending a first image request from the client to a second server;
serving a redirect signal to the client in response to said first image request;
sending a second image request from the client to said second server; and
serving content to the client.
